(19) United States
(12) Patent Application Publication
(10) Pub. No.: US 2017/0308235 A1
(43) Pub. Date: Oct. 26, 2017

(54) FLOATING TOUCH METHOD

(71) Applicant: SHENZHEN CHINA STAR OPTOELECTRONICS TECHNOLOGY CO., LTD., SHENZHEN (CN)

(72) Inventors: Yu Shu Hsu, Taipei City (TW); Yu Hao Chang, Taipei City (TW); Cho-Yi Lin, Taipei City (TW)

(21) Appl. No.: 15/648,471

(22) Filed: Jul. 13, 2017

Related U.S. Application Data
(63) Continuation of application No. 14/661,531, filed on Mar. 18, 2015.

(30) Foreign Application Priority Data
Dec. 26, 2014 (TW) 103145652

(51) Int. Cl. G06F 3/041; G06F 3/0488; G06F 3/0481; G06F 3/0484

(52) U.S. Cl. CPC G06F 3/0416; G06F 3/04842; G06F 3/04883; G06F 3/04812; G06F 2203/04106; G06F 2203/04806; G06F 2203/04808; G06F 2203/04101

(57) ABSTRACT

A floating touch method for an electronic device is disclosed. The method includes detecting at least one position of at least one operation object near a screen of the electronic device to generate at least one three-dimensional coordinate; and displaying at least one position indicator on the screen according to at least one two-dimensional coordinate which is a projection of the at least one three-dimensional on the screen, wherein, the electronic apparatus updates a display of the at least one two-dimensional coordinate and the at least one position indicator at any time according to a movement of the at least one operation object, wherein, a size of the at least one position indicator is inversely proportional to a vertical distance which the at least one three-dimensional coordinate distances from the screen.

### CROSS REFERENCE TO RELATED APPLICATIONS

This is a continuation application of co-pending patent application Ser. No. 14/661,531, filed on Mar. 18, 2015.

### BACKGROUND

### 1. Field

This disclosure generally relates to a touch method and, more particularly, to a floating touch method for an electronic apparatus.

### 2. Description of Related Art

With the progress of science and technology, electronic devices, such as smart phones, tablet computers, and etc., have become indispensable in daily life. In order to increase the visual range of the screen of the electronic apparatus, most of the screen of the electronic apparatus may be equipped with resistive or capacitive touch capabilities, so as to the user may perform the operations related to the electronic apparatus.

However, most of the touching manner of the current electronic apparatus is performed by directly touching the screen through the finger of the user, such that the surface of the screen of the electronic apparatus may be stained or scratched. In order to avoid contacting the screen directly, most of the users may use a screen protector to protect the screen, such that the cost is also increased. Therefore, the operation method of the electronic apparatus needs improvement.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a schematic diagram of the electronic apparatus according to a first exemplary embodiment of the disclosure;

FIG. 2 shows a flowchart of the floating touch method according to the first exemplary embodiment of the disclosure;

FIG. 3 shows a flowchart of the floating touch method according to a second exemplary embodiment of the disclosure;

FIG. 4 shows a flowchart of the floating touch method according to a third exemplary embodiment of the disclosure;

FIG. 5 shows a schematic diagram of the electronic apparatus according to the third exemplary embodiment of the disclosure;

FIG. 6 shows a flowchart of the floating touch method according to a fourth exemplary embodiment of the disclosure;

FIG. 7 shows a schematic diagram of the electronic apparatus according to the fourth exemplary embodiment of the disclosure;

FIG. 8 shows a flowchart of the floating touch method according to a fifth exemplary embodiment of the disclosure;

FIG. 9 shows a schematic diagram of the electronic apparatus according to the fifth exemplary embodiment of the disclosure;

FIG. 10 shows a flowchart of the floating touch method according to a sixth exemplary embodiment of the disclosure;

FIG. 11 shows a schematic diagram of the electronic apparatus according to the sixth exemplary embodiment of the disclosure;

FIG. 12 shows a flowchart of the floating touch method according to a seventh exemplary embodiment of the disclosure;

FIG. 13 shows a schematic diagram of the electronic apparatus according to the seventh exemplary embodiment of the disclosure;

FIG. 14 shows another schematic diagram of the electronic apparatus according to the seventh exemplary embodiment of the disclosure;

FIG. 15 shows a flowchart of the floating touch method according to a eighth exemplary embodiment of the disclosure;

FIG. 16 shows a schematic diagram of the electronic apparatus according to the eighth exemplary embodiment of the disclosure;

FIG. 17 shows a flowchart of the floating touch method according to a ninth exemplary embodiment of the disclosure;

FIG. 18 shows a flowchart of the floating touch method according to a tenth exemplary embodiment of the disclosure;

FIG. 19 shows a schematic diagram of the electronic apparatus according to the tenth exemplary embodiment of the disclosure;

FIG. 20 shows a flowchart of the floating touch method according to a eleventh exemplary embodiment of the disclosure;

FIG. 21 shows a schematic diagram of the electronic apparatus according to the eleventh exemplary embodiment of the disclosure;

FIG. 22 shows another schematic diagram of the electronic apparatus according to the eleventh exemplary embodiment of the disclosure;

FIG. 23 shows a flowchart of the floating touch method according to a twelfth exemplary embodiment of the disclosure;

FIG. 24 shows a schematic diagram of the electronic apparatus according to the twelfth exemplary embodiment of the disclosure;

FIG. 25 shows a flowchart of the floating touch method according to a thirteenth exemplary embodiment of the disclosure;

FIG. 26 shows a schematic diagram of the electronic apparatus according to the thirteenth exemplary embodiment of the disclosure;

FIG. 27 shows a flowchart of the floating touch method according to a fourteenth exemplary embodiment of the disclosure; and

FIG. 28 shows a flowchart of the floating touch method according to a fifteenth exemplary embodiment of the disclosure.

### DETAILED DESCRIPTION

Referring to the drawings, embodiments of the present disclosure are described in more detail. The detailed description below is intended as a description of various configurations of the subject technology and is not intended to represent the only configuration in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block schematic diagram form in order to avoid obscuring the concepts of the subject technology. Like components are labeled with identical element numbers for ease of understanding.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect. Additionally the term “couple” or “connect” covers any direct or indirect electrically coupling means. Therefore when one device is electrically connected to another device in the context, that connection may be through a direct electrical connection, or through an indirect electrical connection via other devices and connections. The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

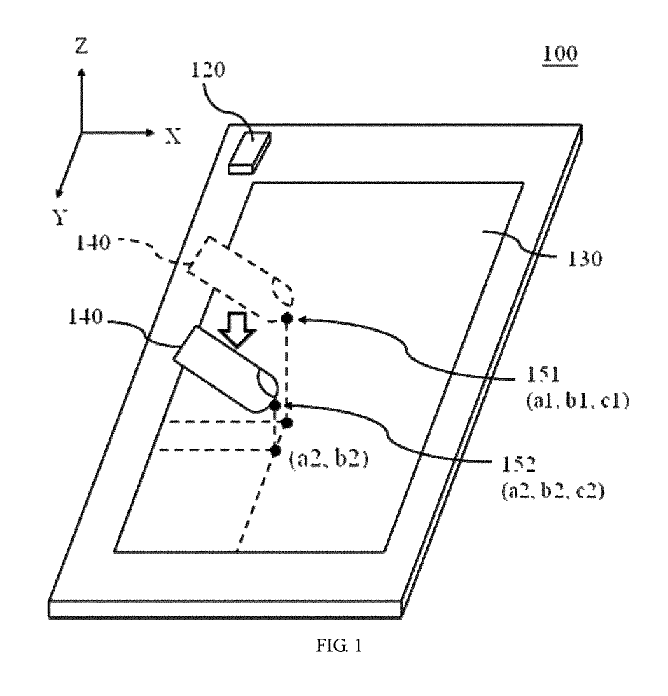

FIG. 1 shows a schematic diagram of the electronic apparatus according to a first exemplary embodiment of the disclosure. The electronic apparatus 100 of the disclosure includes, for example, a mobile phone, a tablet computer and so on. The electronic apparatus is equipped at least one detector 120 and a processor. The detector 120 is disposed, for example, on a corner of at least one side of the electronic apparatus 100 and detects whether the operation object 140 appears near a screen 130 of the electronic apparatus 100 so as to generate a detecting signal to the processor, such that the processor performs a corresponding calculation. The detector 120 detects the operation object 140 by using an optical scanning method, a light reflection detecting method, or a photograph method. The operation object 140 may be, for example, the finger of a user.

The brief description above is related to the electronic device 100. The further description is given in details in accompany with the following floating touch method.

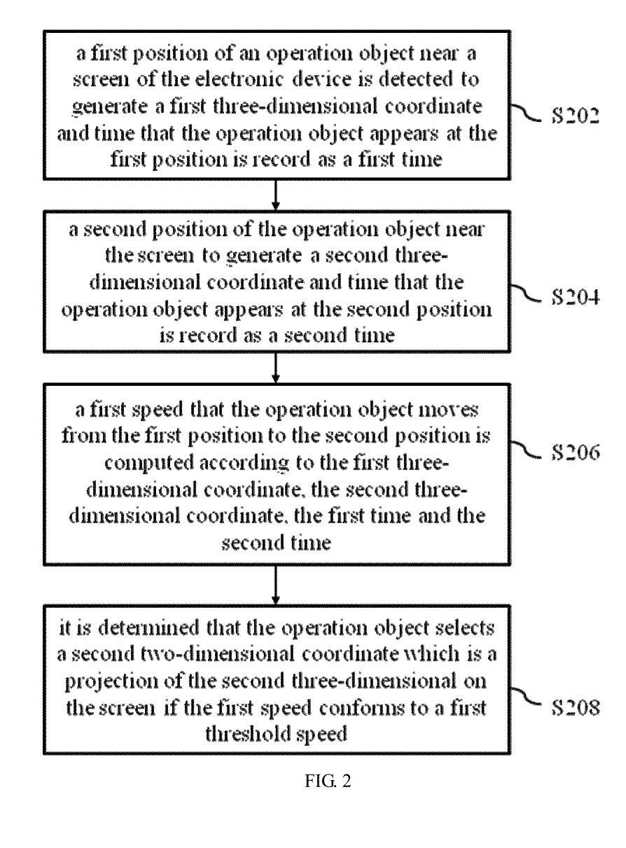

FIG. 2 shows a flowchart of the floating touch method according to the first exemplary embodiment of the disclosure. In the step S202, a first position 151 of an operation object 140 near a screen of the electronic device 100 is detected to generate a first three-dimensional coordinate (a1, b1, c1) and time that the operation object 140 appears at the first position 151 is record as a first time T1. That is, when the finger (i.e. the operation object 140) of the user appears at the first position 151 near the screen 130 of the electronic apparatus 100, i.e. the operation object 140 enters to a detecting region of detector 120, the detector 120 may detect the operation object 140 and generate a first detecting signal to the processor of the electronic apparatus 100. Then, the processor obtains the first position 151 of the operation object 140 near the screen 130 according to the calculation of the first detecting signal. The processor performs a coordinate calculation for the first position 151 to generate a corresponding first three-dimensional coordinate (a1, b1, c1). And, the processor further records time that the operation object 140 appears at the first position 151 as the first time T1.

In the step S204, a second position 152 of the operation object 140 near the screen 130 to generate a second three-dimensional coordinate (a2, b2, c2) and time that the operation object 140 appears at the second position 152 is record as a second time T2. That is when the finger (i.e. the operation object 140) of the user appears at the second position 152 near the screen 130 of the electronic apparatus 100, i.e. the finger of the user is moved in a vertical direction, the detector 120 may generate a corresponding second detecting signal to the processor of the electronic apparatus 100. Then, the processor obtains the second position 152 of the operation object 140 near the screen 130 according to the calculation of the second detecting signal. The processor performs a coordinate calculation for the second position 152 to generate a corresponding second three-dimensional coordinate (a2, b2, c2). And, the processor further records time that the operation object 140 appears at the second position 152 as the second time T2.

In the step S206, a first speed that the operation object 140 moves from the first position 151 to the second position 152 is computed according to the first three-dimensional coordinate (a1, b1, c1), the second three-dimensional coordinate (a2, b2, c2), the first time T1 and the second time T2. That is, when the processor obtains the first three-dimensional coordinate (a1, b1, c1), the second three-dimensional coordinate (a2, b2, c2), the first time T1 and the second time T2, the processor subtracts the first Z coordinate c1 form the second Z coordinate c2 and subtracts the first time T1 from the second time T2, and then divides the subtracted coordinate (c2−c1) by the subtracted time (T2−T1) so as to compute the first speed that the operation object 140 moves from the first position 151 to the second position 152.

In the step S208, it is determined that the operation object 140 selects a second two-dimensional coordinate (a2, b2) which is a projection of the second three-dimensional (a2, b2, c2) on the screen 130 if the first speed conforms to a first threshold speed. That is, when the processor obtains the first speed, the processor compares the first speed with a first threshold speed stored at the processor to determine that whether the first speed conforms to a first threshold speed.

For example, the first threshold speed is −0.5 cm/sec. If the first speed is less than or equals to, for example, −0.5 cm/sec, the processor may determine that the first speed conforms to the first threshold speed. Then, the processor may determine that the operation object 140 selects the second two-dimensional coordinate (a2, b2) which is a projection of the second three-dimensional (a2, b2, c2) on the screen 130, i.e. the user wants to select and operate a object defined on the second two-dimensional coordinate (a2, b2).

If the first speed is greater than, for example, −0.5 cm/sec, the processor may determine that the first speed does not conform to the first threshold speed. Then, the processor dose not perform any operation. Therefore, the electronic apparatus 100 is operated by the user without touching the screen 130 of the electronic apparatus 100, such that a surface of the screen 130 of the electronic apparatus 100 is not stained or scratched so as to increase a convenience of usage.

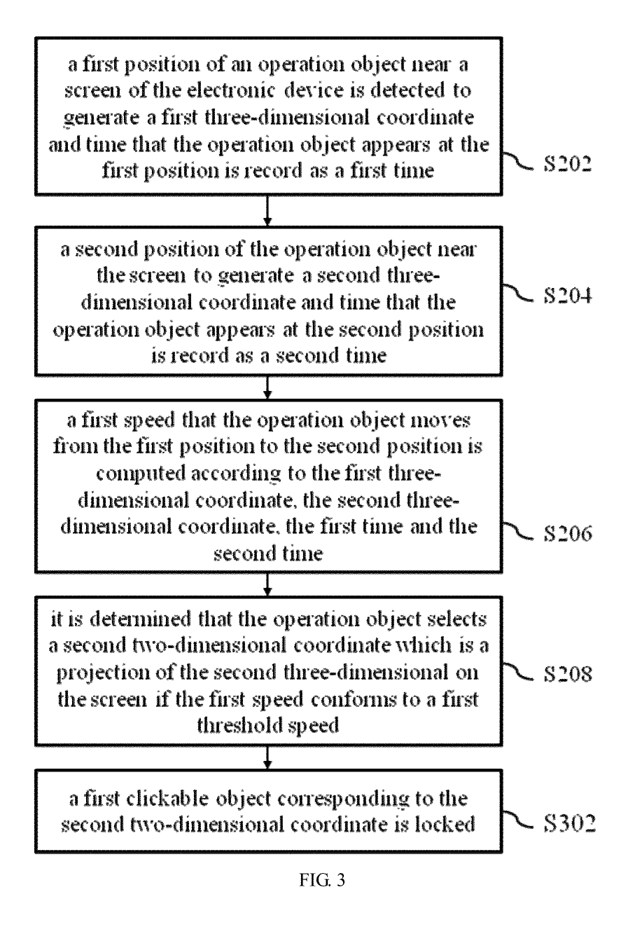

FIG. 3 shows a flowchart of the floating touch method according to a second exemplary embodiment of the disclosure. In the embodiment, the description of the steps S202, S204, S206, S208 can be found in the description of the embodiment in FIG. 2. Thus, the description is omitted. The embodiment in FIG. 3 further includes the step S302, which is different from the embodiment in FIG. 2.

In the step S302, a first clickable object corresponding to the second two-dimensional coordinate (a2, b2) is locked. That is, when the processor determines that the operation object 140 selects the second two-dimensional coordinate (a2, b2) which is a projection of the second three-dimensional (a2, b2, c2), the processor may lock the first clickable object corresponding to the second two-dimensional coordinate (a2, b2), it is indicated that the user selects the first clickable object displayed on the screen 130. The clickable object may be, for example, an Icon of the application program. Therefore, the user may still select the object displayed on the screen 130 by using the above method without touching the screen 130 and then the electronic apparatus 100 may performs the corresponding operations.

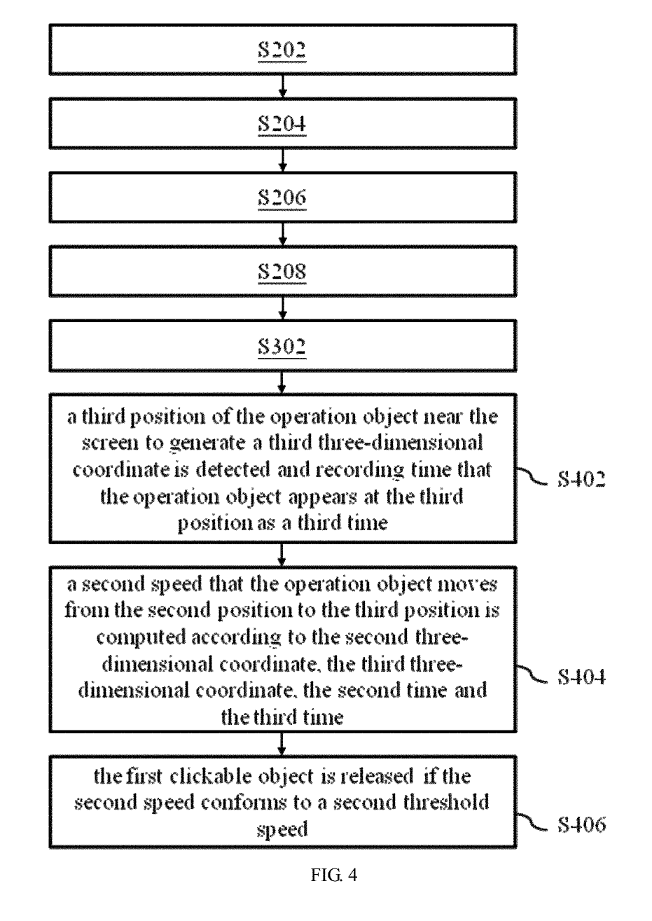

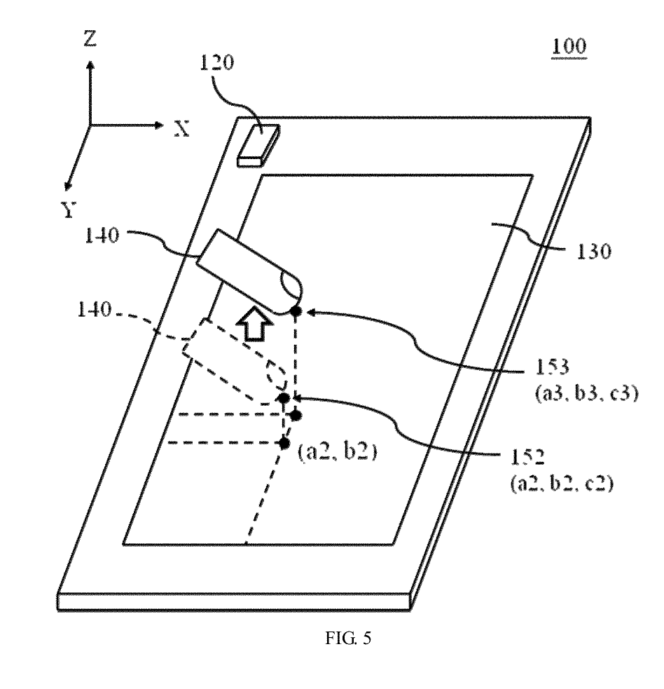

FIG. 4 shows a flowchart of the floating touch method according to a third exemplary embodiment of the disclosure. FIG. 5 shows a schematic diagram of the electronic apparatus according to the third exemplary embodiment of the disclosure. In the embodiment, the description of the steps S202, S204, S206, S208, S302 can be found in the description of the embodiment in FIG. 3. Thus, the description is omitted. The embodiment in FIG. 4 further includes the steps S402, S404, S406, which is different from the embodiment in FIG. 3.

In the step S402, a third position 153 of the operation object 140 near the screen 130 to generate a third three-dimensional coordinate (a3, b3, c3) is detected and recording time that the operation object 140 appears at the third position 153 as a third time T3. That is, when the finger (i.e. the operation object 140) of the user moves to the third position 153 near the screen 130 of the electronic apparatus 100, the detector 120 may generate a third detecting signal to the processor of the electronic apparatus 100. Then, the processor obtains the third position 153 of the operation object 140 near the screen 130 according to the calculation of the third detecting signal. The processor performs a coordinate calculation for the third position 153 to generate a corresponding third three-dimensional coordinate (a3, b3, c3). And, the processor further records time that the operation object 140 appears at the third position 153 as the third time T3.

In the step S404, a second speed that the operation object 140 moves from the second position 152 to the third position 153 is computed according to the second three-dimensional coordinate (a2, b2, c2), the third three-dimensional coordinate (a3, b3, c3), the second time T2 and the third time T3. That is, when the processor obtains the third three-dimensional coordinate (a3, b3, c3) and the third time T3, the processor subtracts the second Z coordinate c2 form the third Z coordinate c3 and subtracts the second time T2 from the third time T3, and then divides the subtracted coordinate (c3−c2) by the subtracted time (T3−T2) so as to compute the second speed that the operation object 140 moves from the second position 152 to the third position 153.

In the step S406, the first clickable object is released if the second speed conforms to a second threshold speed. That is, when the processor obtains the second speed, the processor compares the second speed with a second threshold speed stored in the processor to determine that whether the second speed conforms to a second threshold speed.

For example, the second threshold speed is −0.5 cm/sec. If the second speed is greater than or equals to, for example, −0.5 cm/sec, the processor may determine that the second speed conforms to the second threshold speed. Then, the processor may release the first clickable object, i.e. the finger of the user already leaves the first clickable object and the object defined on the second two-dimensional coordinate (a2, b2) does not selected.

If the second speed is less than, for example, −0.5 cm/sec, the processor may determine that the second speed does not conform to the second threshold speed. Then, the processor still locks the first clickable object. Therefore, the above operation manner is achieved as the same as the operation manner which the finger of the user touches the screen 130 and then leaves the screen 130.

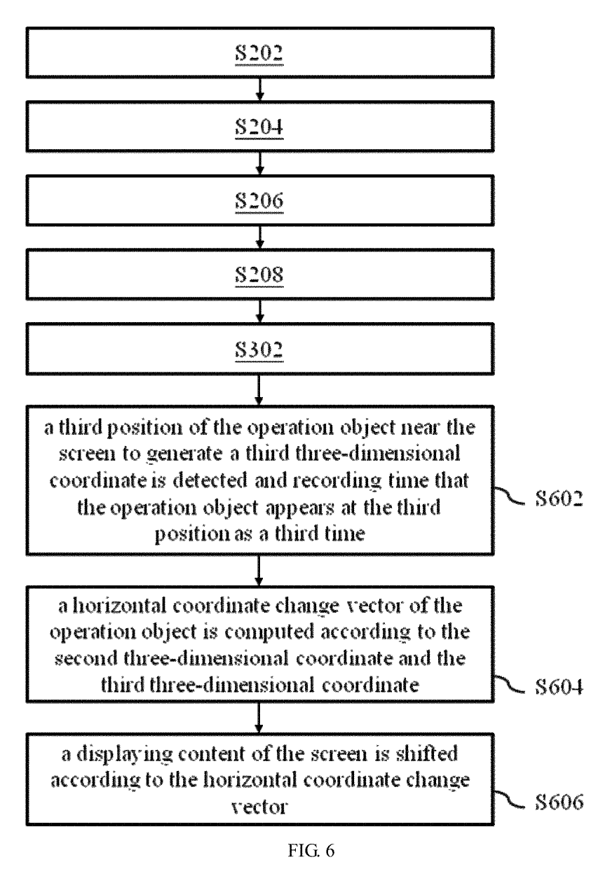

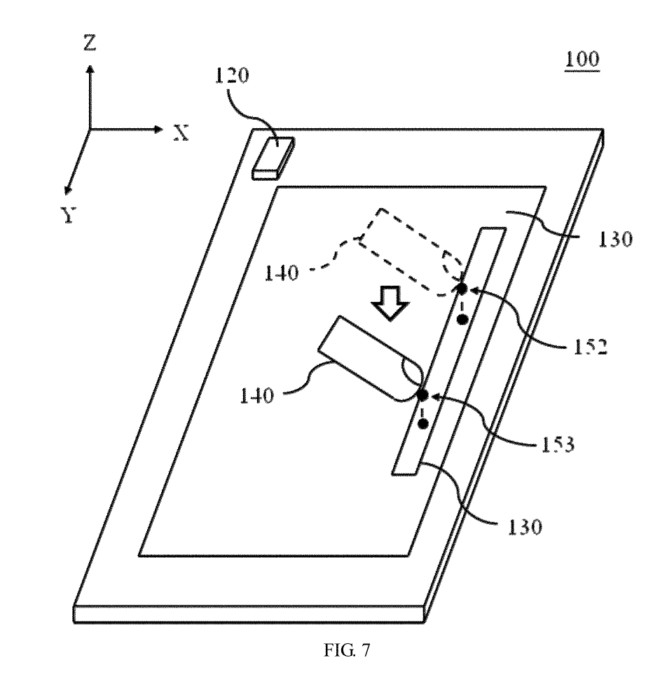

FIG. 6 shows a flowchart of the floating touch method according to a fourth exemplary embodiment of the disclosure. FIG. 7 shows a schematic diagram of the electronic apparatus according to the fourth exemplary embodiment of the disclosure. In the embodiment, the description of the steps S202, S204, S206, S208, S302 can be found in the description of the embodiment in FIG. 3. Thus, the description is omitted. The embodiment in FIG. 6 further includes the steps S602, S604 and S606, which are different from the embodiment in FIG. 3.

In the step S602, a third position 153 of the operation object 140 near the screen 130 to generate a third three-dimensional coordinate (a3, b3, c3) is detected and recording time that the operation object 140 appears at the third position 153 as a third time T3. That is, when the finger (i.e. the operation object 140) of the user moves to the third position 153 near the screen 130 of the electronic apparatus 100, i.e. the finger of the user is moved in a horizontal direction, the detector 120 may generate a third detecting signal to the processor of the electronic apparatus 100. Then, the processor obtains the third position 153 of the operation object 140 near the screen 130 according to the calculation of the third detecting signal. The processor performs a coordinate calculation for the third position 153 to generate a corresponding third three-dimensional coordinate (a3, b3, c3). And, the processor further records time that the operation object 140 appears at the third position 153 as the third time T3.

In the step S604, a horizontal coordinate change vector of the operation object 140 is computed according to the second three-dimensional coordinate (a2, b2, c2) and the third three-dimensional coordinate (a3, b3, c3). That is, when the processor obtains the second three-dimensional coordinate (a2, b2, c2) and the third three-dimensional coordinate (a3, b3, c3), the processor subtracts the second Y coordinate b2 form the third Y coordinate b3 so as to compute the horizontal coordinate change vector of the operation object 140.

In the step S606, a displaying content of the screen 130 is shifted according to the horizontal coordinate change vector. That is, when the processor computes the horizontal coordinate change vector corresponding to the operation object 140, the processor may generate a amount of corresponding inversely movement according to the horizontal coordinate change vector. Then, the processor shifts the displaying content of the screen 130 according to the amount of corresponding inversely movement. Namely, when the finger of the user is moved from the second position 152 to the third position 153, the displaying content of the screen 130 may by shifted from the third position 153 to the second position 152. Therefore, the corresponding operation of browsing web pages is achieved without touching the screen 130 by the finger of the user.

In this embodiment, the operation object 140 is, for example, moved in a horizontal direction of Y axis, and it is not limited to the disclosure. The operation 140 may also move in a horizontal direction of X axis. The description for detecting the movement may refer the above description, and the description is omitted.

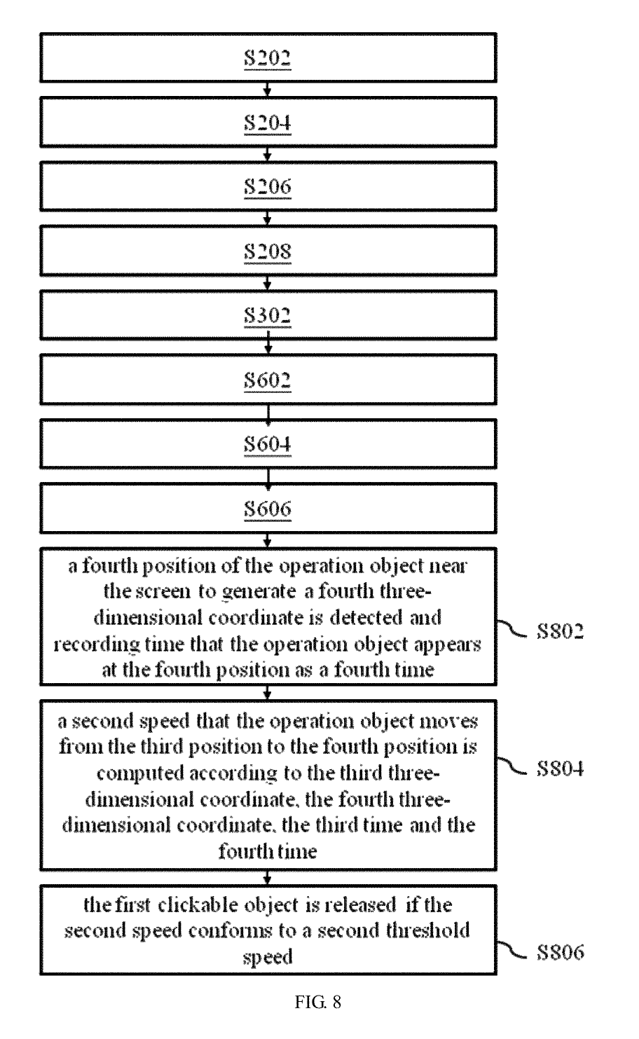

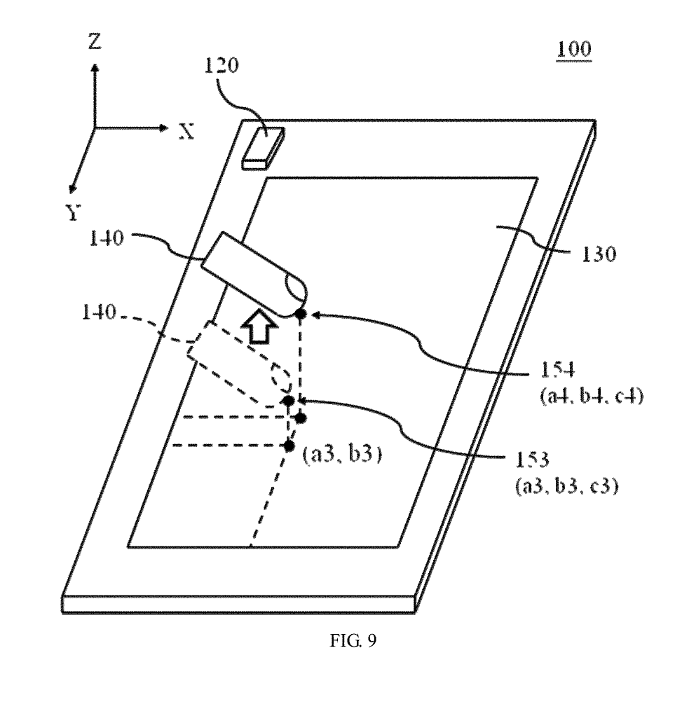

FIG. 8 shows a flowchart of the floating touch method according to a fifth exemplary embodiment of the disclosure. FIG. 9 shows a schematic diagram of the electronic apparatus according to the fifth exemplary embodiment of the disclosure. In the embodiment, the description of the steps S202, S204, S206, S208, S302, S602, S604, S606 can be found in the description of the embodiment in FIG. 6. Thus, the description is omitted. The embodiment in FIG. 8 further includes the steps S802, S804 and S806, which are different from the embodiment in FIG. 6.

In the step S802, a fourth position 154 of the operation object 140 near the screen 130 to generate a fourth three-dimensional coordinate (a4, b4, c4) is detected and recording time that the operation object 140 appears at the fourth position 154 as a fourth time T4. That is, when the finger (i.e. the operation object 140) of the user moves to the fourth position 154 near the screen 130 of the electronic apparatus 100, the detector 120 may generate a fourth detecting signal to the processor of the electronic apparatus 100. Then, the processor obtains the fourth position 154 of the operation object 140 near the screen 130 according to the calculation of the fourth detecting signal. The processor performs a coordinate calculation for the fourth position 154 to generate a corresponding fourth three-dimensional coordinate (a4, b4, c4). And, the processor further records time that the operation object 140 appears at the fourth position 154 as the fourth time T4.

In the step S804, a second speed that the operation object 140 moves from the third position 153 to the fourth position 154 is computed according to the third three-dimensional coordinate (a3, b3, c3), the fourth three-dimensional coordinate (a4, b4, c4), the third time T3 and the fourth time T4. That is, when the processor obtains the fourth three-dimensional coordinate (a4, b4, c4) and the fourth time T4, the processor subtracts the third Z coordinate c3 form the fourth Z coordinate c4 and subtracts the third time T3 from the fourth time T4, and then divides the subtracted coordinate (c4−c3) by the subtracted time (T4−T3) so as to compute the second speed that the operation object 140 moves from the third position 153 to the fourth position 154.

In the step S806, the first clickable object is released if the second speed conforms to a second threshold speed. The relative operation of the step S806 is similar as that of the step S406. The description of the step S806 can be found in the description of the embodiment of the step S406 in FIG. 4, and thus the description is omitted herein. Therefore, the above operation manner is achieved as the same as the operation manner which the finger of the user touches the screen 130 and then leaves the screen 130.

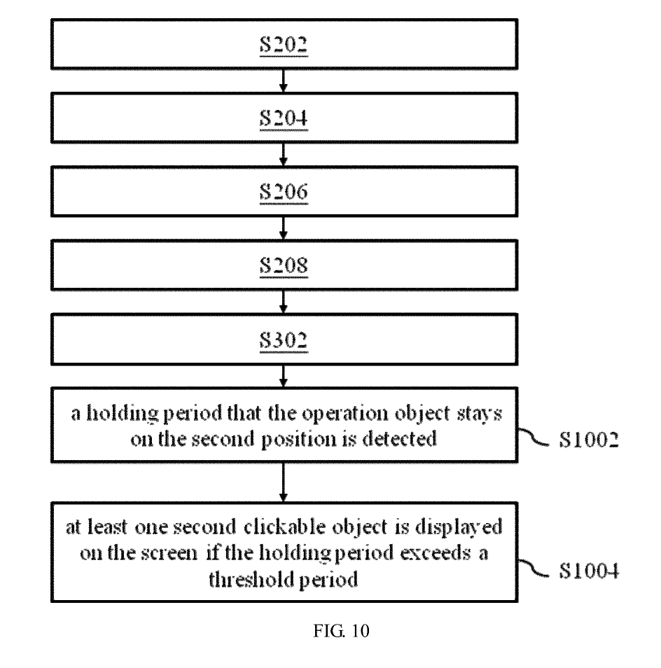

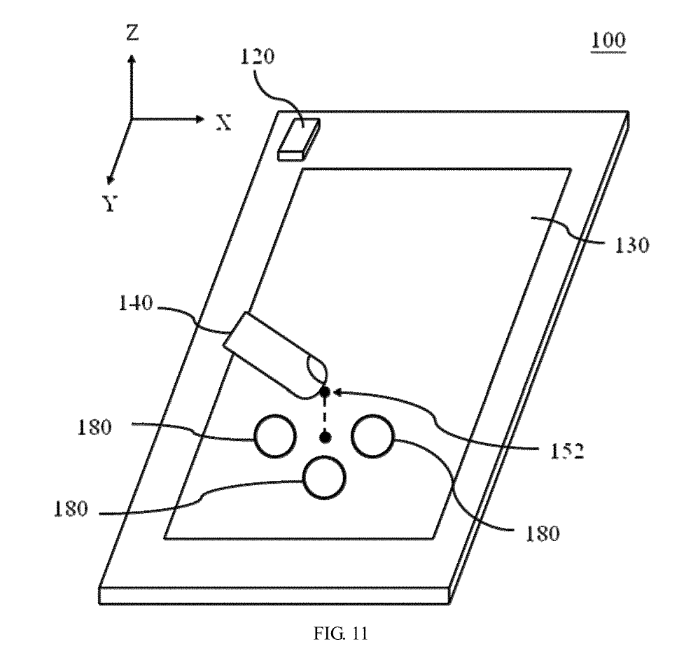

FIG. 10 shows a flowchart of the floating touch method according to a sixth exemplary embodiment of the disclosure. FIG. 11 shows a schematic diagram of the electronic apparatus according to the sixth exemplary embodiment of the disclosure. In the embodiment, the description of the steps S202, S204, S206, S208, S302 can be found in the description of the embodiment in FIG. 3. Thus, the description is omitted. The embodiment in FIG. 10 further includes the steps S1002 and S1004, which are different from the embodiment in FIG. 3.

In the step S1002, a holding period that the operation object 140 stays on the second position 152 is detected. That is, if the finger of the user still stays on the second position 152, the detector 120 may continue to provide the second detecting signal to the processor. When the processor determines that the detector 120 still continues to provide the second detecting signal corresponding to the second position 152, the processor may start to count and then gather the holding time that the operation object 140 stays on the second position.

In the step S1004, at least one second clickable object 180 is displayed on the screen 130 if the holding period exceeds a threshold period. For example, the threshold period is 2 seconds. If the holding time is less than, for example, 2 seconds, the processor determines that the holding time does not exceed the threshold period. Then, the processor does not perform any operations.

If the holding period is greater than or equals to, for example, 2 seconds, the processor may determine that the holding period exceeds the threshold period. Then, the processor may display, for example, at least one second clickable object 180 on the screen 130. The second clickable object 180 may be, for example, a selection item of a relative object, such as removing this application program, removing the first page shortcut and so on. Therefore, the above operation manner is achieved as the same as or similar to the operation manner which the finger of the user presses the screen 130 for a long time to display the corresponding relative object. The mount of the second clickable object is, for example, three, and it is not limited to the disclosure. The mount of the second clickable object may, for example, one, two or above three.

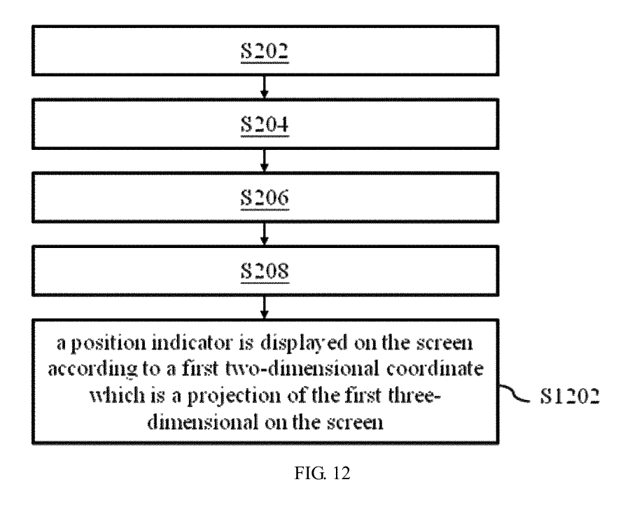

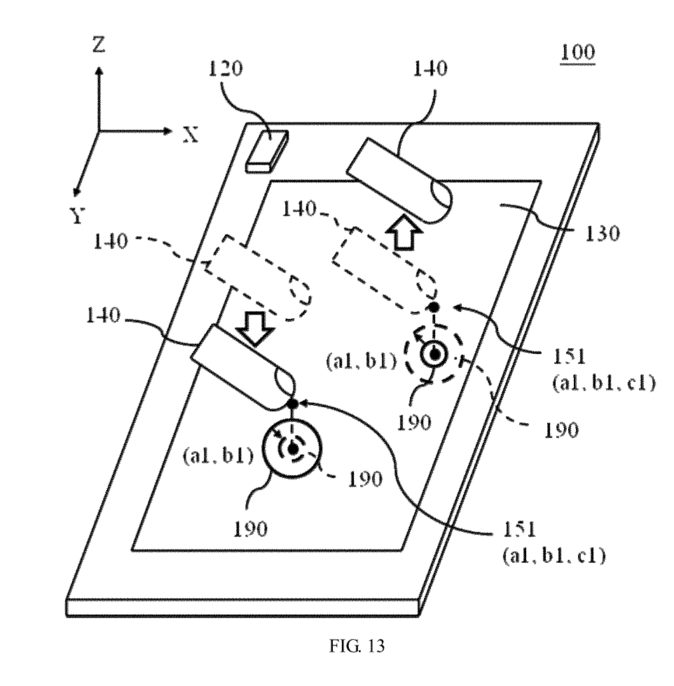

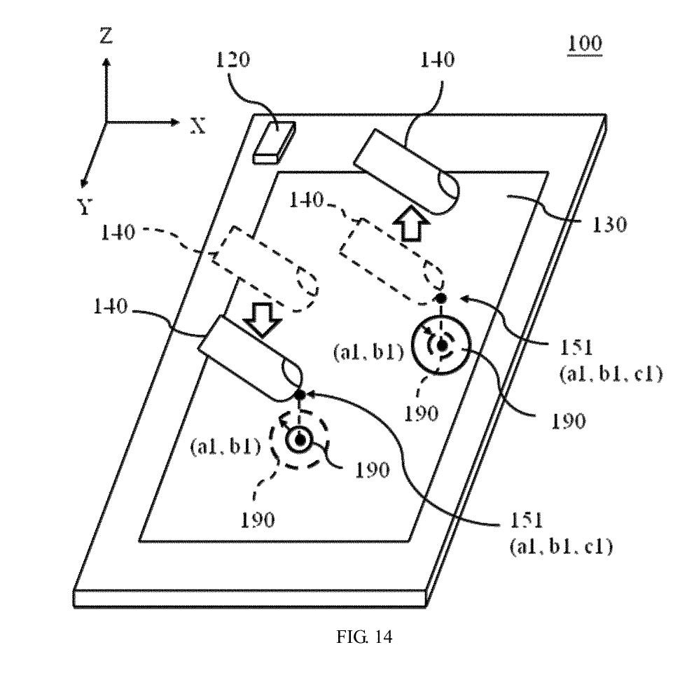

FIG. 12 shows a flowchart of the floating touch method according to a seventh exemplary embodiment of the disclosure. FIG. 13 shows a schematic diagram of the electronic apparatus according to the seventh exemplary embodiment of the disclosure. FIG. 14 shows another schematic diagram of the electronic apparatus according to the seventh exemplary embodiment of the disclosure. In the embodiment, the description of the steps S202, S204, S206 and S208 can be found in the description of the embodiment in FIG. 2. Thus, the description is omitted. The embodiment in FIG. 12 further includes the step S1202, which is different from the embodiment in FIG. 2.

In the step S1202, a position indicator 190 is displayed on the screen 130 according to a first two-dimensional coordinate (a1, b1) which is a projection of the first three-dimensional (a1, b1, c1) on the screen 130. That is, when the processor obtains the first three-dimensional (a1, b1, c1), the processor may compute the first two-dimensional coordinate (a1, b1) corresponding to the screen 130 according to the first three-dimensional (a1, b1, c1), i.e. the first two-dimensional coordinate (a1, b1) which is a projection of the first three-dimensional (a1, b1, c1) on the screen 130. Accordingly, the processor then displays the position indicator 190 corresponding to the first two-dimensional coordinate (a1, b1) on the screen 130.

And, the processor of the electronic apparatus 100 further updates a display of the first two-dimensional coordinate (a1, b1) and the position indicator 190 at any time according to a movement of the operation object 140. That is, the finger of the user may moves near the screen 130 of the electronic apparatus 100, the processor of the electronic apparatus 100 may update the corresponding first two-dimensional coordinate (a1, b1) and display the corresponding position indicator 190 following the position moved by the finger of the user.

In one embodiment, a size of the position indicator 190 is, for example, inversely proportional to a vertical distance which the first three-dimensional coordinate (a1, b1, c1) distances from the screen 130, as shown in FIG. 13. For example, when the distance between the first three-dimensional (a1, b1, c1) and the screen 130 is far, i.e. the distance between the operation object 140 and the screen 130 in the vertical direction is far, and the figure of the position indicator 190 is small. On the contrary, when the distance between the first three-dimensional (a1, b1, c1) and the screen 130 is close, i.e. the distance between the operation object 140 and the screen 130 in the vertical direction is close, and the figure of the position indicator 190 is large. That is, when the operation object 140 gradually approaches to the screen 130, the figure of the position indicator 190 is gradually zoomed in. When the operation object 140 gradually leaves form the screen 130, the figure of the position indicator 190 is gradually zoomed out.

In another embodiment, a size of the position indicator 190 is, for example, proportional to a vertical distance which the first three-dimensional coordinate (a1, b1, c1) distances from the screen 130, as shown in FIG. 14. For example, when the distance between the first three-dimensional (a1, b1, c1) and the screen 130 is far, i.e. the distance between the operation object 140 and the screen 130 in the vertical direction is far, and the figure of the position indicator 190 is large. On the contrary, when the distance between the first three-dimensional (a1, b1, c1) and the screen 130 is close, i.e. the distance between the operation object 140 and the screen 130 at the vertical direction is close, and the figure of the position indicator 190 is small. That is, when the operation object 140 gradually approaches to the screen 130, the figure of the position indicator 190 is gradually zoomed out. When the operation object 140 gradually leaves form the screen 130, the figure of the position indicator 190 is gradually zoomed in. Therefore, the operation for displaying the position corresponding to the finger of the user is achieved without touching the screen 130.

In above embodiment, the description of the floating touch method is, for example, used for a single touch manner, and it is not limited to the disclosure. The disclosure of the floating touch method may also used for a multi touch manner. Some other embodiments are illustrated as following.

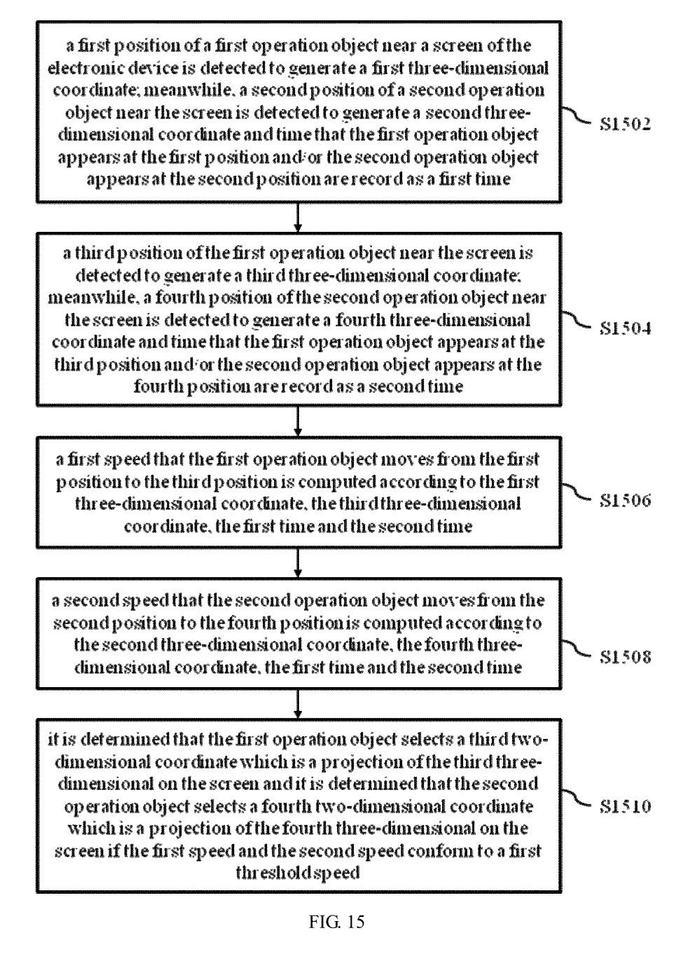

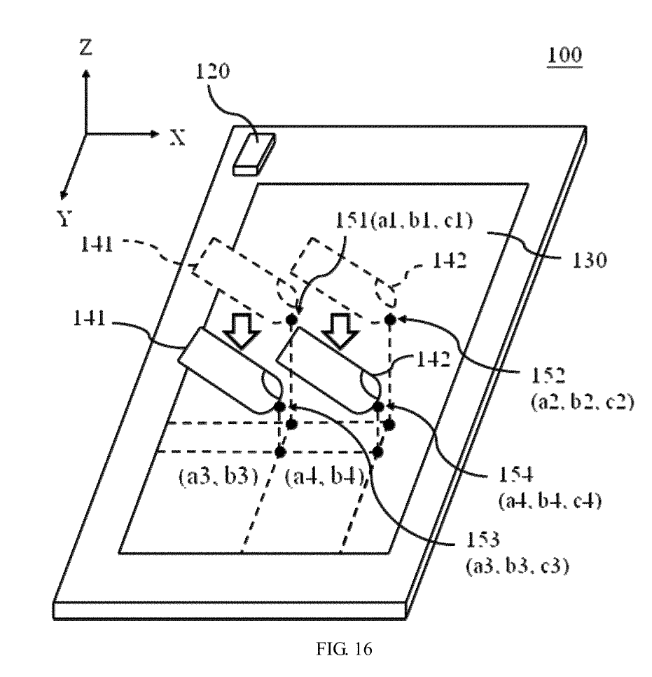

FIG. 15 shows a flowchart of the floating touch method according to a eighth exemplary embodiment of the disclosure. FIG. 16 shows a schematic diagram of the electronic apparatus according to the eighth exemplary embodiment of the disclosure. In the step S1502, a first position 151 of a first operation object 141 near a screen 130 of the electronic device 100 is detected to generate a first three-dimensional coordinate (a1, b1, c1); meanwhile, a second position 152 of a second operation object 142 near the screen 130 is detected to generate a second three-dimensional coordinate (a2, b2, c2) and time that the first operation object 141 appears at the first position 151 and/or the second operation object 142 appears at the second position 152 are record as a first time T1.

In the step S1504, a third position 153 of the first operation object 141 near the screen 130 is detected to generate a third three-dimensional coordinate (a3, b3, c3); meanwhile, a fourth position 154 of the second operation object 142 near the screen 130 is detected to generate a fourth three-dimensional coordinate (a4, b4, c4) and time that the first operation object 141 appears at the third position 153 and/or the second operation object 142 appears at the fourth position 154 are record as a second time T2.

In the step S1506, a first speed that the first operation object 141 moves from the first position 151 to the third position 153 is computed according to the first three-dimensional coordinate (a1, b1, c1), the third three-dimensional coordinate (a3, b3, c3), the first time T1 and the second time T2.

In the step S1508, a second speed that the second operation object 142 moves from the second position 152 to the fourth position 154 is computed according to the second three-dimensional coordinate (a2, b2, c2), the fourth three-dimensional coordinate (a4, b4, c4), the first time T1 and the second time T2.

In the step S1510, it is determined that the first operation object 141 selects a third two-dimensional coordinate (a3, b3) which is a projection of the third three-dimensional (a3, b3, c3) on the screen 130 and it is determined that the second operation object 142 selects a fourth two-dimensional coordinate (a4, b4) which is a projection of the fourth three-dimensional (a4, b4, c4) on the screen 130 if the first speed and the second speed conform to a first threshold speed.

In the embodiment, the step S1502 is similar to the step S202 in FIG. 2, the step S1504 is similar to the step 204 in FIG. 2, the steps S1506 and S1508 are similar to the step S206 in FIG. 2, and the step S1510 is similar to the step S208. The description of the steps S1502, S1504, 1506, S1508, and S1510 can be refer to the description of the embodiment in FIG. 2, and the description is omitted. Therefore, the electronic apparatus 100 is operated by the user without touching the screen 130 of the electronic apparatus 100, such that a surface of the screen 130 of the electronic apparatus 100 is not stained or scratched so as to increase a convenience of usage.

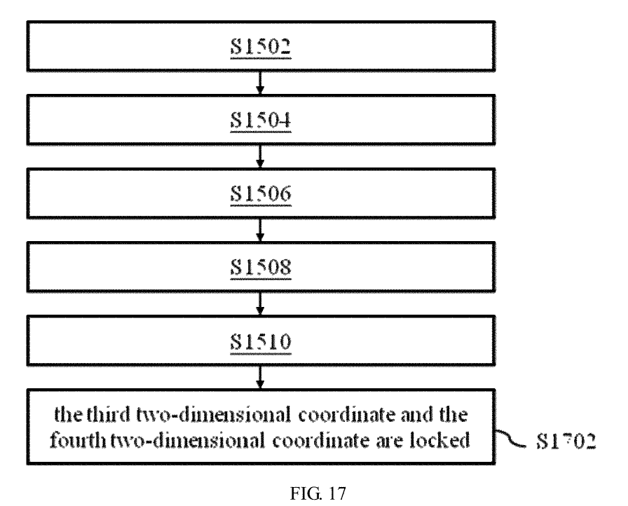

FIG. 17 shows a flowchart of the floating touch method according to a ninth exemplary embodiment of the disclosure. In the embodiment, the description of the steps S1502, S1504, S1506, S1508 and S1510 can be found in the description of the embodiment in FIG. 15. Thus, the description is omitted. The embodiment in FIG. 17 further includes the step S1702, which is different from the embodiment in FIG. 15.

In the step S1702, the third two-dimensional coordinate (a3, b3) and the fourth two-dimensional coordinate (a4, b4) are locked. The step S1702 of locking the third two-dimensional coordinate (a3, b3) and the fourth two-dimensional coordinate (a4, b4) is similar to the step S302 of locking the second two-dimensional coordinate (a2, b2). The description of the step S1702 can be refer to the description of the embodiment in FIG. 2, and the description is omitted. Therefore, the electronic apparatus 100 is operated by the user in a multi-touch manner without touching the screen 130 of the electronic apparatus 100, so as to lock two coordinates corresponding to the positions of the first operation object 141 and the second operation object 142.

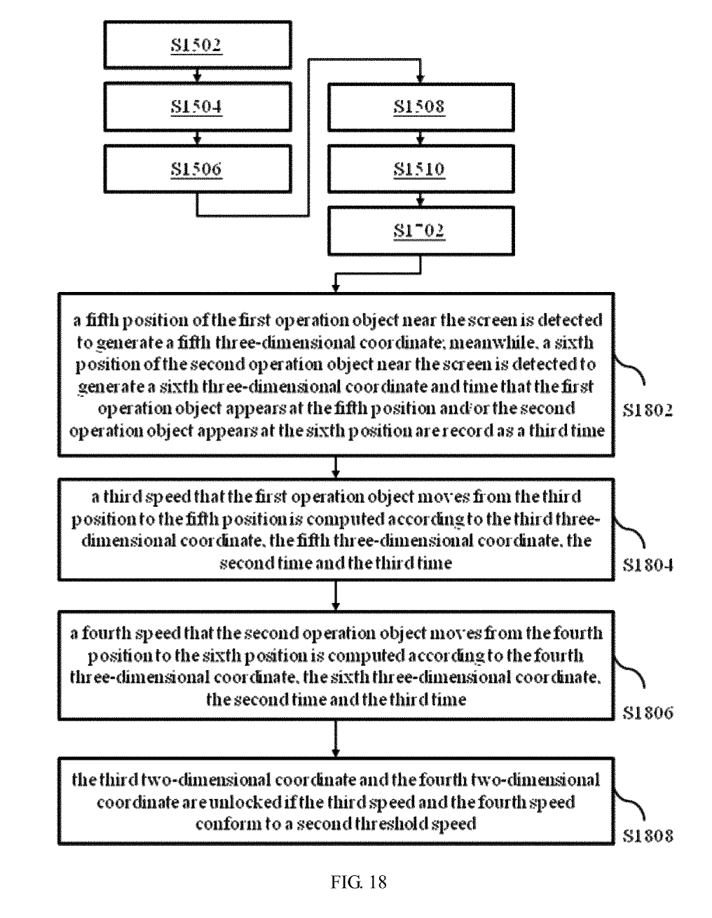

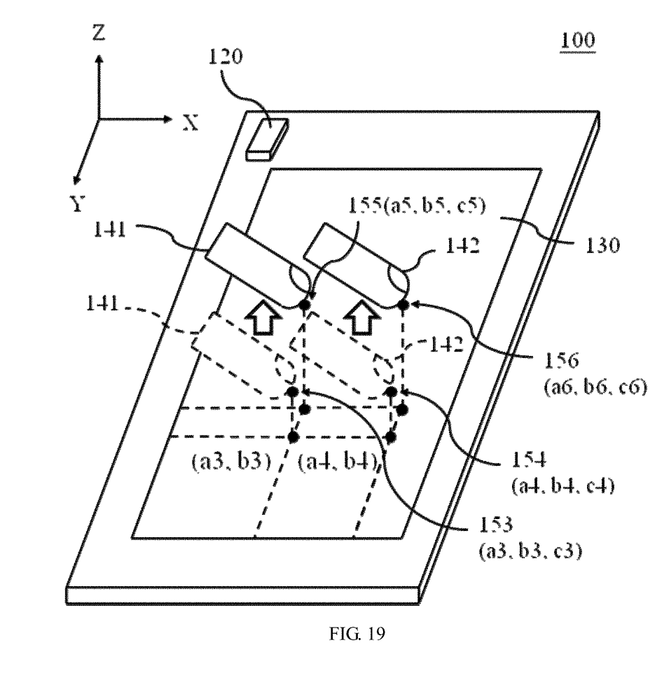

FIG. 18 shows a flowchart of the floating touch method according to a tenth exemplary embodiment of the disclosure. FIG. 19 shows a schematic diagram of the electronic apparatus according to the tenth exemplary embodiment of the disclosure. In the embodiment, the description of the steps S1502, S1504, S1506, S1508, S1510 and S1702 can be found in the description of the embodiment in FIG. 17. Thus, the description is omitted. The embodiment in FIG. 18 further includes the steps S1802, S1804, S1806 and S1808, which are different from the embodiment in FIG. 17.

In the step S1802, a fifth position 155 of the first operation object 141 near the screen 130 is detected to generate a fifth three-dimensional coordinate (a5, b5, c5); meanwhile, a sixth position 156 of the second operation object 142 near the screen 130 is detected to generate a sixth three-dimensional coordinate (a6, b6, c6) and time that the first operation object 141 appears at the fifth position 155 and/or the second operation object 142 appears at the sixth position 156 are record as a third time T3.

In the step S1804, a third speed that the first operation object 141 moves from the third position 153 to the fifth position 155 is computed according to the third three-dimensional coordinate (a3, a3, a3), the fifth three-dimensional coordinate (a5, b5, c5), the second time T2 and the third time T3.

In the step S1806, a fourth speed that the second operation object 142 moves from the fourth position 154 to the sixth position 156 is computed according to the fourth three-dimensional coordinate (a4, a4, a4), the sixth three-dimensional coordinate (a6, b6, c6), the second time T2 and the third time T3.

In the step S1808, the third two-dimensional coordinate (a3, b3) and the fourth two-dimensional coordinate (a4, b4) are unlocked if the third speed and the fourth speed conform to a second threshold speed.

In the embodiment, the step S1802 is similar to the step S402 in FIG. 4, the steps S1804 and S1806 are similar to the step S404 in FIG. 4, the step S1808 is similar to the step S406 in FIG. 4. The description of the steps S1802, S1804, S1806 and S1808 can be refer to the description of the embodiment in FIG. 4, and the description is omitted. Therefore, the above multi touch operation manner is achieved as the same as the operation manner which the finger of the user touches the screen 130 and then leaves the screen 130.

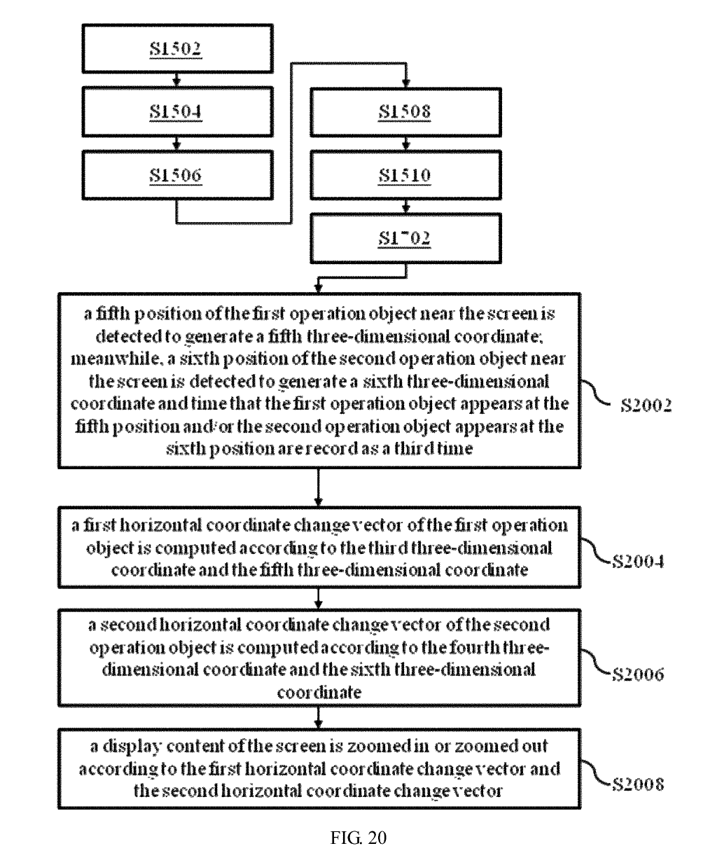

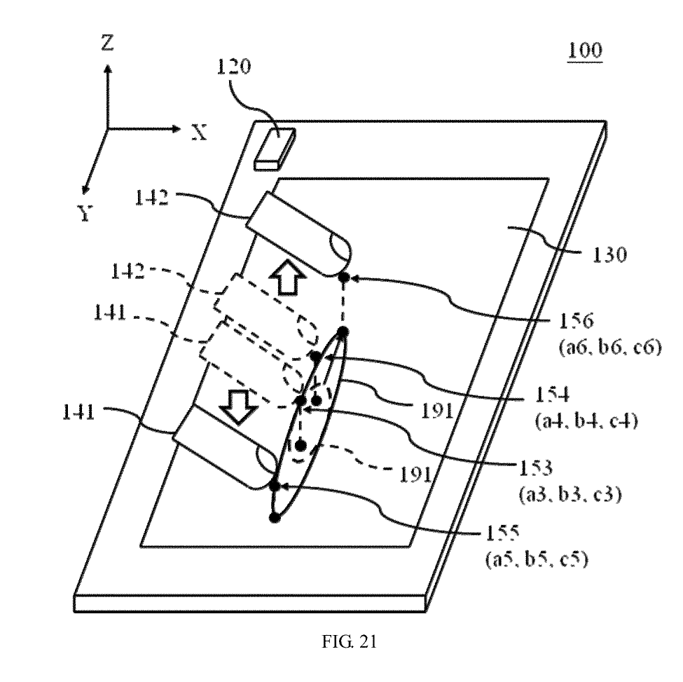

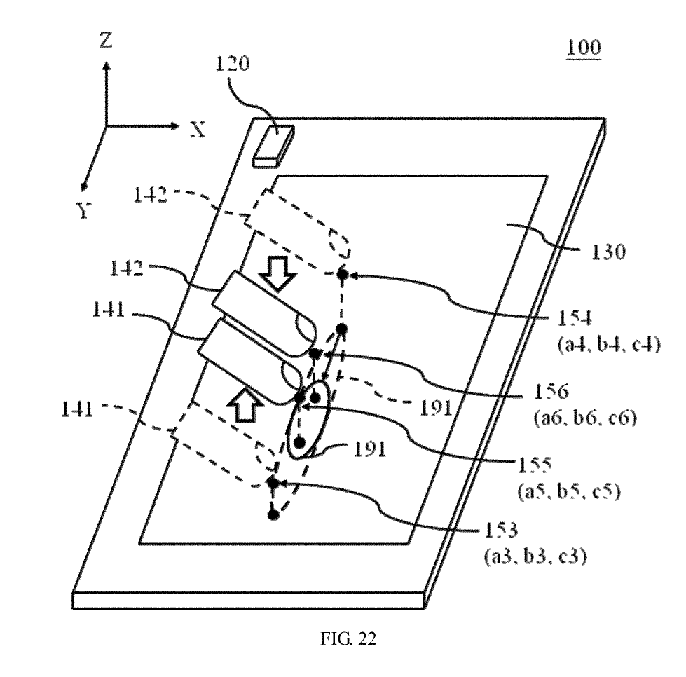

FIG. 20 shows a flowchart of the floating touch method according to a eleventh exemplary embodiment of the disclosure. FIG. 21 shows a schematic diagram of the electronic apparatus according to the eleventh exemplary embodiment of the disclosure. FIG. 22 shows another schematic diagram of the electronic apparatus according to the eleventh exemplary embodiment of the disclosure. In the embodiment, the description of the steps S1502, S1504, S1506, S1508, S1510, and S1702 can be found in the description of the embodiment in FIG. 17. Thus, the description is omitted. The embodiment in FIG. 18 further includes the steps S2002, S2004, S2006 and S2008, which is different from the embodiment in FIG. 17.

In the step S2002, a fifth position 155 of the first operation object 141 near the screen 130 is detected to generate a fifth three-dimensional coordinate (a5, b5, c5); meanwhile, a sixth position 156 of the second operation object 142 near the screen 130 is detected to generate a sixth three-dimensional coordinate (a6, b6, c6) and time that the first operation object 141 appears at the fifth position 155 and/or the second operation object 142 appears at the sixth position 156 are record as a third time T3.

In the step S2004, a first horizontal coordinate change vector of the first operation object 141 is computed according to the third three-dimensional coordinate (a3 b3, c3) and the fifth three-dimensional coordinate (a5, b5, c5).

In the step S2006, a second horizontal coordinate change vector of the second operation object 142 is computed according to the fourth three-dimensional coordinate (a4 b4, c4) and the sixth three-dimensional coordinate (a6, b6, c6).

In the embodiment, the step S2002 is similar to the step S602 in FIG. 6, and the steps S2004 and S2006 are similar to the step S604 in FIG. 6. The description of the steps S2002, S2004 and S2006 can be refer to the description of the embodiment in FIG. 6, and the description is omitted.

In the step S2008, a display content 191 of the screen 130 is zoomed in or zoomed out according to the first horizontal coordinate change vector and the second horizontal coordinate change vector. For example, if the first horizontal coordinate change vector and the second horizontal coordinate change vector computed by the processor indicates that the distance between the two fingers of the user is gradually increased, the processor zooms in the display content 191 of the screen 130, as shown in FIG. 21. On the contrary, if the first horizontal coordinate change vector and the second horizontal coordinate change vector computed by the processor indicates that the distance between the two fingers of the user is gradually decreased, the processor zooms out the display content 191 of the screen 130, as shown in FIG. 22.

Therefore, the display content of the web page zoomed out or zoomed in when browsing the web page is achieved by operating the electronic apparatus in the multi touch manner without touching the screen 130 by the finger of the user.

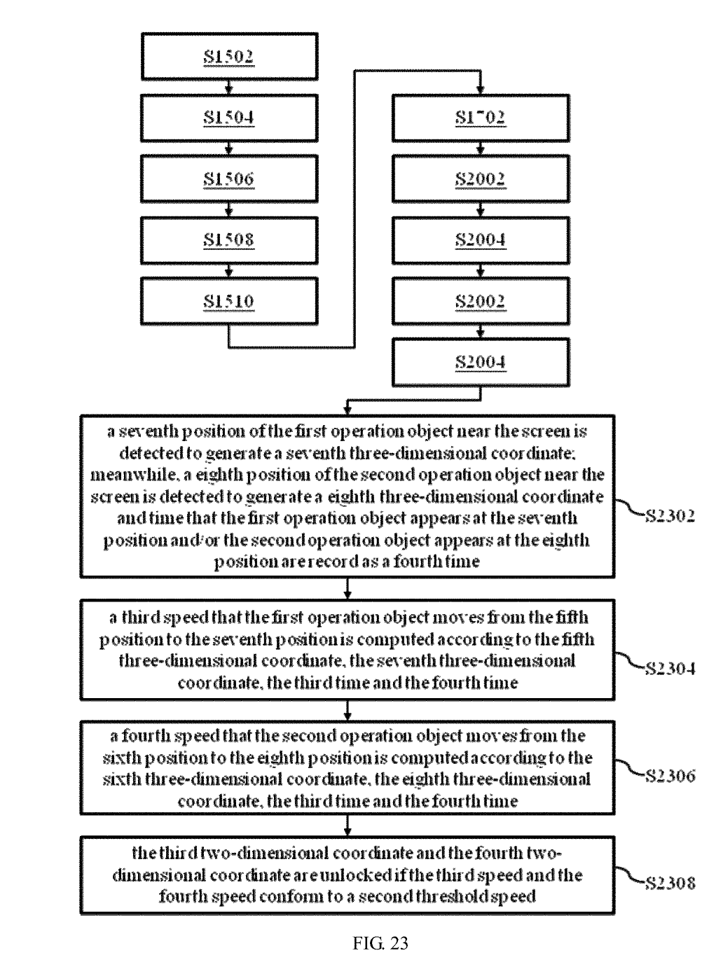

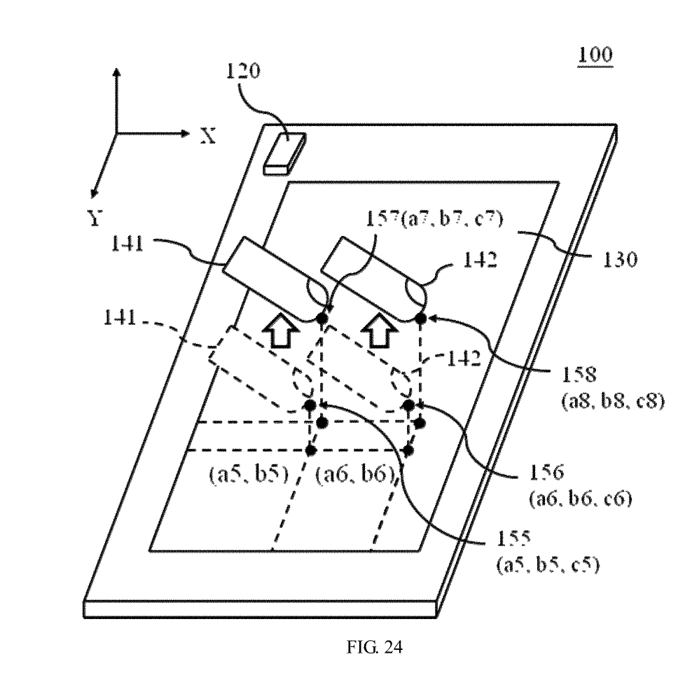

FIG. 23 shows a flowchart of the floating touch method according to a twelfth exemplary embodiment of the disclosure. FIG. 24 shows a schematic diagram of the electronic apparatus according to the twelfth exemplary embodiment of the disclosure. In the embodiment, the description of the steps S1502, S1504, S1506, S1508, S1510, S1702, S2002, S2004, S2006 and S2008 can be found in the description of the embodiment in FIG. 20. Thus, the description is omitted. The embodiment in FIG. 23 further includes the steps S2302, S2304, S2306 and S2308, which are different from the embodiment in FIG. 20.

In the step S2302, a seventh position 157 of the first operation object 141 near the screen 130 is detected to generate a seventh three-dimensional coordinate (a7, b7, c7); meanwhile, a eighth position 158 of the second operation object 142 near the screen 130 is detected to generate a eighth three-dimensional coordinate (a8, b8, c8) and time that the first operation object 141 appears at the seventh position 157 and/or the second operation object 142 appears at the eighth position 158 are record as a fourth time T4.

In the step S2304, a third speed that the first operation object 141 moves from the fifth position 155 to the seventh position 157 is computed according to the fifth three-dimensional coordinate (a5, b5, c5), the seventh three-dimensional coordinate (a7, b7, c7), the third time T3 and the fourth time T4. In the step S2306, a fourth speed that the second operation object 142 moves from the sixth position 156 to the eighth position 158 is computed according to the sixth three-dimensional coordinate (a6, b6, c6), the eighth three-dimensional coordinate (a8, b8, c8), the third time T3 and the fourth time T4. In the step S2308, the third two-dimensional coordinate (a5, b5) and the fourth two-dimensional coordinate (a6, b6) are unlocked if the third speed and the fourth speed conform to a second threshold speed.

In the embodiment, the step S2302 is similar to the step S802 in FIG. 8, the steps S2304 and S2306 are similar to the step S804 in FIG. 8, the step S2308 is similar to the step S806 in FIG. 8. The description of the steps S2302, S2304, S2306 and S2308 can be refer to the description of the embodiment in FIG. 8, and the description is omitted. Therefore, the above multi touch operation manner is achieved as the same as the operation manner which the finger of the user touches the screen 130 and then leaves the screen 130.

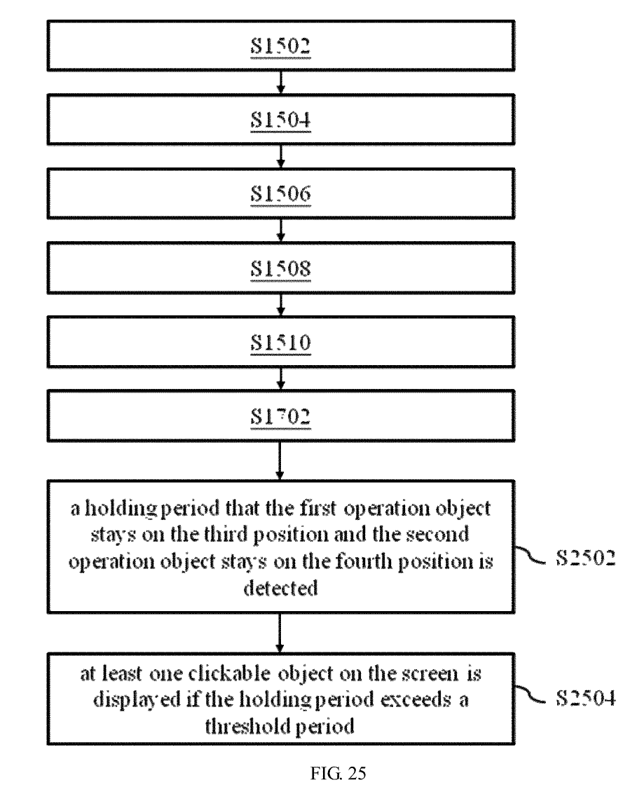

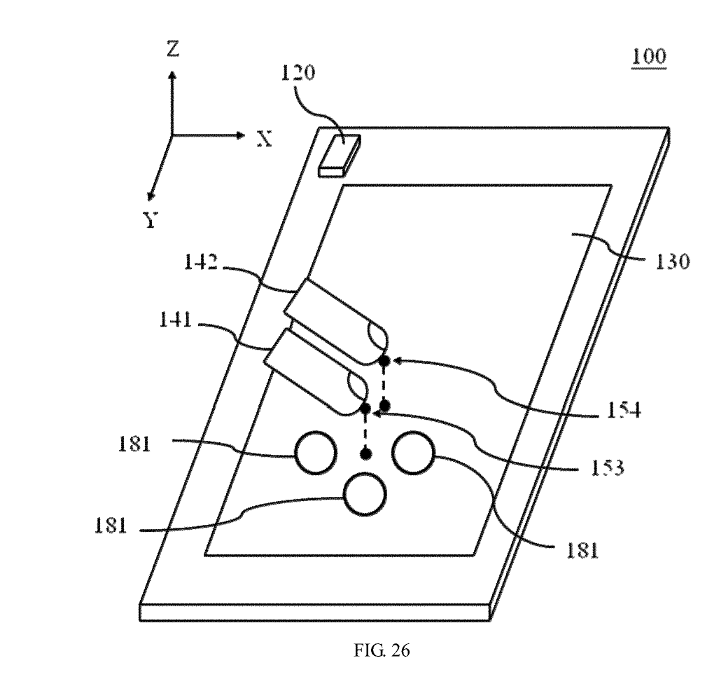

FIG. 25 shows a flowchart of the floating touch method according to a thirteenth exemplary embodiment of the disclosure. FIG. 26 shows a schematic diagram of the electronic apparatus according to the thirteenth exemplary embodiment of the disclosure. In the embodiment, the description of the steps S1502, S1504, S1506, S1508, S1510 and S1702 can be found at the description of the embodiment in FIG. 17. Thus, the description is omitted. The embodiment in FIG. 25 further includes the steps S2502 and S2504, which are different from the embodiment in FIG. 17.

In the step S2502, a holding period that the first operation object 141 stays on the third position 153 and the second operation object 142 stays on the fourth position 154 is detected. In the step S2504, at least one clickable object 181 on the screen 130 is displayed if the holding period exceeds a threshold period.

In the embodiment, the step S2502 is similar to the step S1002 in FIG. 10, and the step S2504 is similar to the step S1004 in FIG. 10. The description of the steps S2502 and S2504 can be refer to the description of the embodiment in FIG. 8, and the description is omitted. Therefore, the above operation manner is achieved as the same as or similar to the operation manner which the finger of the user presses the screen 130 for a long time to display the corresponding relative object. The mount of the clickable object is, for example, three, and it is not limited to the disclosure. The mount of the clickable object may, for example, one, two or above three.

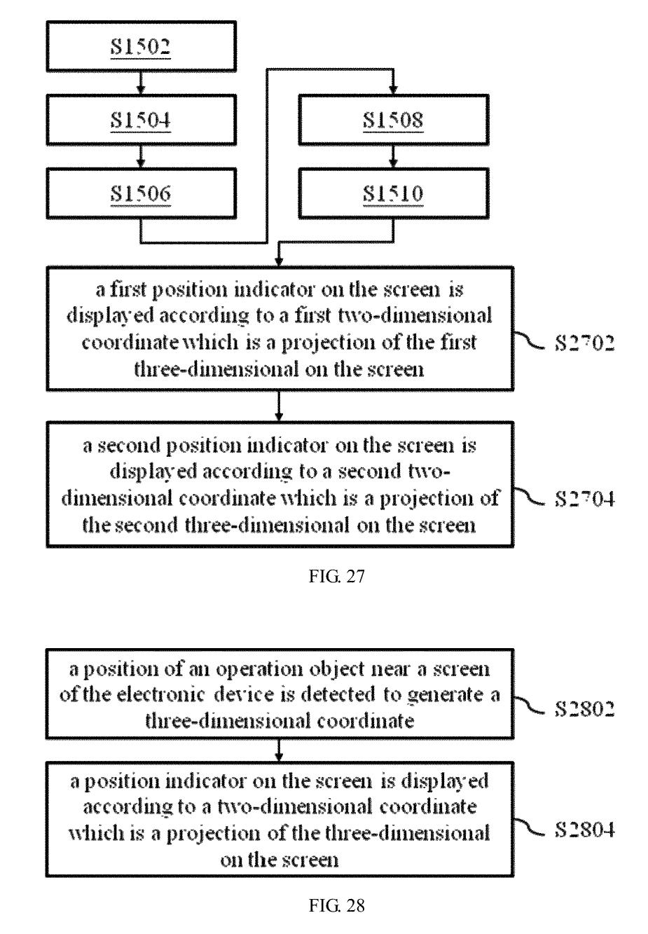

FIG. 27 shows a flowchart of the floating touch method according to a fourteenth exemplary embodiment of the disclosure. In the embodiment, the description of the steps S1502, S1504, S1506, S1508 and S1510 can be found in the description of the embodiment in FIG. 15. Thus, the description is omitted. The embodiment in FIG. 27 further includes the steps S2702 and S2704, which are different from the embodiment in FIG. 15.

In the step S2702, a first position indicator on the screen is displayed according to a first two-dimensional coordinate which is a projection of the first three-dimensional on the screen. In the step S2704, a second position indicator on the screen is displayed according to a second two-dimensional coordinate which is a projection of the second three-dimensional on the screen.

In the embodiment, the steps S2702 and S2764 are similar to the step S1202 in FIG. 12. The description of the steps S2502 and S2504 can be refer to the description of the embodiment in FIG. 12, and the description is omitted. That is, the electronic apparatus 100 may update a display of the first two-dimensional coordinate, a display of the second two-dimensional coordinate, the first position indicator and the second position indicator at any time according to a movement of the first operation object and the second operation object.

Additionally, in one embodiment, a size of the first position indicator is, for example, inversely proportional to a first vertical distance which the first three-dimensional coordinate distances from the screen, and a size of the second position indicator is, for example, inversely proportional to a second vertical distance which the second three-dimensional coordinate distances from the screen. The change of the first position indicator and the second position indicator may refer the change of the position indicator 190 as shown in FIG. 13, and the description is omitted.

In another embodiment, a size of the first position indicator is, for example, proportional to a first vertical distance which the first three-dimensional coordinate distances from the screen, and a size of the second position indicator is, for example, proportional to a second vertical distance which the second three-dimensional coordinate distances from the screen. The change of the first position indicator and the second position indicator may refer the change of the position indicator 190 as shown in FIG. 14, and the description is omitted. Therefore, the operation for displaying the position corresponding to the finger of the user is achieved without touching the screen 130.

FIG. 28 shows a flowchart of the floating touch method according to a fifteenth exemplary embodiment of the disclosure. In the step S2802, a position of an operation object near a screen of the electronic device is detected to generate a three-dimensional coordinate. In the step S2804, a position indicator on the screen is displayed according to a two-dimensional coordinate which is a projection of the three-dimensional on the screen.

In the embodiment, the step S2802 is similar to the step S202 in FIG. 2, the step S2804 is similar to the step S1202 in FIG. 12. The description of the steps S2802 and S2804 can be refer to the description of the embodiment in FIG. 2 and FIG. 12, and the description is omitted. That is, the electronic apparatus 100 may update a display of the two-dimensional coordinate and the position indicator at any time according to a movement of the operation object 140.

Additionally, in one embodiment, a size of the position indicator is, for example, inversely proportional to a vertical distance which the three-dimensional coordinate distances from the screen. The change of the position indicator may refer the change of the position indicator 190 as shown in FIG. 13, and the description is omitted. In another embodiment, a size of the position indicator is, for example, proportional to a vertical distance which the three-dimensional coordinate distances from the screen. The change of the position indicator may refer the change of the position indicator 190 as shown in FIG. 14, and the description is omitted. Therefore, the operation for displaying the position corresponding to the finger of the user is achieved without touching the screen 130.

According to the floating touch method of the above-mentioned embodiments, a position of an operation object near a screen of the electronic device is detected to generate a corresponding three-dimensional coordinate and then the relative operation is performed accordingly. Additionally, a plurality of positions of multi operation objects near the screen of the electronic are also detected to generate a plurality of corresponding three-dimensional coordinate and then the relative operations are performed accordingly. Therefore, the electronic apparatus is operated by the user without touching the screen of the electronic apparatus, such that a surface of the screen of the electronic apparatus is not stained or scratched so as to increase a convenience of usage.

Although the disclosure has been explained in relation to its preferred embodiment, it does not intend to limit the disclosure. It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A floating touch method, used for an electronic apparatus, comprising:
detecting at least one position of at least one operation object near a screen of the electronic device to generate at least one three-dimensional coordinate; and
displaying at least one position indicator on the screen according to at least one two-dimensional coordinate which is a projection of the at least one three-dimensional on the screen,
wherein, the electronic apparatus updates a display of the at least one two-dimensional coordinate and the at least one position indicator at any time according to a movement of the at least one operation object,
wherein, a size of the at least one position indicator is inversely proportional to a vertical distance which the at least one three-dimensional coordinate distances from the screen.

2. The floating touch method as claimed in claim 1, wherein the detecting at least one position of at least one operation object near a screen of the electronic device to generate at least one three-dimensional coordinate further comprises:
detecting at least one first position of at least one operation object near a screen of the electronic device to generate at least one first three-dimensional coordinate; and
detecting at least one second position of the at least one operation object near the screen to generate at least one second three-dimensional coordinate;
after the displaying at least one position indicator on the screen according to at least one two-dimensional coordinate which is a projection of the at least one three-dimensional on the screen, the method further comprises:
performing at least one relative operation on the screen according to a movement of the at least one operation object from the at least one first three-dimensional coordinate to the at least one second three-dimensional coordinate and at least one second two-dimensional coordinate which is a projection of the at least one second three-dimensional on the screen.

3. The floating touch method as claimed in claim 2, wherein the at least one operation object comprises an operation object;
the detecting at least one first position of at least one operation object near a screen of the electronic device to generate at least one first three-dimensional coordinate further comprises:
detecting a position of an operation object near a screen of the electronic device to generate a first three-dimensional coordinate and recording time that the operation object appears at the first position as a first time;
the detecting at least one second position of the at least one operation object near the screen to generate at least one second three-dimensional coordinate further comprises:
detecting a second position of the operation object near the screen to generate a second three-dimensional coordinate and recording time that the operation object appears at the second position as a second time;
the performing at least one relative operation on the screen according to a movement of the at least one operation object from the at least one first three-dimensional coordinate to the at least one second three-dimensional coordinate and at least one second two-dimensional coordinate which is a projection of the at least one second three-dimensional on the screen further comprises:
computing a first speed that the operation object moves from the first position to the second position according to the first three-dimensional coordinate, the second three-dimensional coordinate, the first time and the second time; and
determining that the operation object selects a second two-dimensional coordinate which is a projection of the second three-dimensional on the screen if the first speed conforms to a first threshold speed.

4. The floating touch method as claimed in claim 3, further comprising:
locking a first clickable object corresponding to the second two-dimensional coordinate.

5. The floating touch method as claimed in claim 4, further comprising:
detecting a third position of the operation object near the screen to generate a third three-dimensional coordinate and recording time that the operation object appears at the third position as a third time;
computing a second speed that the operation object moves from the second position to the third position according to the second three-dimensional coordinate, the third three-dimensional coordinate, the second time and the third time; and
releasing the first clickable object if the second speed conforms to a second threshold speed.

6. The floating touch method as claimed in claim 4, further comprising:
detecting a third position of the operation object near the screen to generate a third three-dimensional coordinate and recording time that the operation object appears at the third position as a third time;
computing a horizontal coordinate change vector of the operation object according to the second three-dimensional coordinate and the third three-dimensional coordinate; and
shifting a displaying content of the screen according to the horizontal coordinate change vector.

7. The floating touch method as claimed in claim 6, further comprising:
detecting a fourth position of the operation object near the screen to generate a fourth three-dimensional coordinate and recording time that the operation object appears at the fourth position as a fourth time;
computing a second speed that the operation object moves from the third position to the fourth position according to the third three-dimensional coordinate, the fourth three-dimensional coordinate, the third time and the fourth time; and
releasing the first clickable object if the second speed conforms to a second threshold speed.

8. The floating touch method as claimed in claim 4, further comprising:
detecting a holding period that the operation object stays on the second position; and
displaying at least one second clickable object on the screen if the holding period exceeds a threshold period.

9. The floating touch method as claimed in claim 1, wherein the at least one operation object comprises two operation objects;
the detecting at least one position of at least one operation object near a screen of the electronic device to generate at least one three-dimensional coordinate further comprises:
detecting a first position of a first operation object near a screen of the electronic device to generate a first three-dimensional coordinate, and detecting a second position of a second operation object near the screen to generate a second three-dimensional coordinate and recording time that the first operation object appears at the first position and/or the second operation object appears at the second position as a first time; and
detecting a third position of the first operation object near the screen to generate a third three-dimensional coordinate, and detecting a fourth position of the second operation object near the screen to generate a fourth three-dimensional coordinate and recording time that the first operation object appears at the third position and/or the second operation object appears at the fourth position as a second time;
after displaying at least one position indicator on the screen according to at least one two-dimensional coordinate which is a projection of the at least one three-dimensional on the screen, the method further comprises:
computing a first speed that the first operation object moves from the first position to the third position according to the first three-dimensional coordinate, the third three-dimensional coordinate, the first time and the second time;
computing a second speed that the second operation object moves from the second position to the fourth position according to the second three-dimensional coordinate, the fourth three-dimensional coordinate, the first time and the second time; and
determining that the first operation object selects a third two-dimensional coordinate which is a projection of the third three-dimensional on the screen and determining that the second operation object selects a fourth two-dimensional coordinate which is a projection of the fourth three-dimensional on the screen if the first speed and the second speed conform to a first threshold speed.

10. A floating touch method, used for an electronic apparatus, comprising:
detecting at least one position of at least one operation object near a screen of the electronic device to generate at least one three-dimensional coordinate; and
displaying at least one position indicator on the screen according to at least one two-dimensional coordinate which is a projection of the at least one three-dimensional on the screen,
wherein, the electronic apparatus updates a display of the at least one two-dimensional coordinate and the at least one position indicator at any time according to a movement of the at least one operation object,
wherein, a size of the at least one position indicator is proportional to a vertical distance which the at least one three-dimensional coordinate distances from the screen.

11. The floating touch method as claimed in claim 10, wherein the at least one operation object comprises two operation objects;
the detecting at least one position of at least one operation object near a screen of the electronic device to generate at least one three-dimensional coordinate further comprises:
detecting a first position of a first operation object near a screen of the electronic device to generate a first three-dimensional coordinate, and detecting a second position of a second operation object near the screen to generate a second three-dimensional coordinate and recording time that the first operation object appears at the first position and/or the second operation object appears at the second position as a first time;
detecting a third position of the first operation object near the screen to generate a third three-dimensional coordinate, and detecting a fourth position of the second operation object near the screen to generate a fourth three-dimensional coordinate and recording time that the first operation object appears at the third position and/or the second operation object appears at the fourth position as a second time;
after the displaying at least one position indicator on the screen according to at least one two-dimensional coordinate which is a projection of the at least one three-dimensional on the screen, the method further comprises:
computing a first speed that the first operation object moves from the first position to the third position according to the first three-dimensional coordinate, the third three-dimensional coordinate, the first time and the second time;
computing a second speed that the second operation object moves from the second position to the fourth position according to the second three-dimensional coordinate, the fourth three-dimensional coordinate, the first time and the second time; and
determining that the first operation object selects a third two-dimensional coordinate which is a projection of the third three-dimensional on the screen and determining that the second operation object selects a fourth two-dimensional coordinate which is a projection of the fourth three-dimensional on the screen if the first speed and the second speed conform to a first threshold speed.

12. The floating touch method as claimed in claim 11, further comprising:
locking the third two-dimensional coordinate and the fourth two-dimensional coordinate.

13. The floating touch method as claimed in claim 12, further comprising:
detecting a fifth position of the first operation object near the screen to generate a fifth three-dimensional coordinate, and detecting a sixth position of the second operation object near the screen to generate a sixth three-dimensional coordinate and recording time that the first operation object appears at the fifth position and/or the second operation object appears at the sixth position as a third time;
computing a third speed that the first operation object moves from the third position to the fifth position according to the third three-dimensional coordinate, the fifth three-dimensional coordinate, the second time and the third time;
computing a fourth speed that the second operation object moves from the fourth position to the sixth position according to the fourth three-dimensional coordinate, the sixth three-dimensional coordinate, the second time and the third time; and
unlocking the third two-dimensional coordinate and the fourth two-dimensional coordinate if the third speed and the fourth speed conform to a second threshold speed.

14. The floating touch method as claimed in claim 12, further comprising:
detecting a fifth position of the first operation object near the screen to generate a fifth three-dimensional coordinate, and detecting a sixth position of the second operation object near the screen to generate a sixth three-dimensional coordinate and recording time that the first operation object appears at the fifth position and/or the second operation object appears at the sixth position as a third time;
computing a first horizontal coordinate change vector of the first operation object according to the third three-dimensional coordinate and the fifth three-dimensional coordinate;
computing a second horizontal coordinate change vector of the second operation object according to the fourth three-dimensional coordinate and the sixth three-dimensional coordinate; and
zooming in or zooming out a display content of the screen according to the first horizontal coordinate change vector and the second horizontal coordinate change vector.

15. The floating touch method as claimed in claim 14, further comprising:
detecting a seventh position of the first operation object near the screen to generate a seventh three-dimensional coordinate, and detecting a eighth position of the second operation object near the screen to generate a eighth three-dimensional coordinate and recording time that the first operation object appears at the seventh position and/or the second operation object appears at the eighth position as a fourth time;
computing a third speed that the first operation object moves from the fifth position to the seventh position according to the fifth three-dimensional coordinate, the seventh three-dimensional coordinate, the third time and the fourth time;
computing a fourth speed that the second operation object moves from the sixth position to the eighth position according to the sixth three-dimensional coordinate, the eighth three-dimensional coordinate, the third time and the fourth time; and
unlocking the third two-dimensional coordinate and the fourth two-dimensional coordinate if the third speed and the fourth speed conform to a second threshold speed.

16. The floating touch method as claimed in claim 12, further comprising:
detecting a holding period that the first operation object stays on the third position and the second operation object stays on the fourth position; and
displaying at least one clickable object on the screen if the holding period exceeds a threshold period.

17. The floating touch method as claimed in claim 10, wherein the detecting at least one position of at least one operation object near a screen of the electronic device to generate at least one three-dimensional coordinate further comprises:
detecting at least one first position of at least one operation object near a screen of the electronic device to generate at least one first three-dimensional coordinate; and
detecting at least one second position of the at least one operation object near the screen to generate at least one second three-dimensional coordinate;
after the displaying at least one position indicator on the screen according to at least one two-dimensional coordinate which is a projection of the at least one three-dimensional on the screen, the method further comprises:
performing at least one relative operation on the screen according to a movement of the at least one operation object from the at least one first three-dimensional coordinate to the at least one second three-dimensional coordinate and at least one second two-dimensional coordinate which is a projection of the at least one second three-dimensional on the screen.

18. The floating touch method as claimed in claim 17, wherein the at least one operation object comprises an operation object;
the detecting at least one first position of at least one operation object near a screen of the electronic device to generate at least one first three-dimensional coordinate further comprises:
detecting a position of an operation object near a screen of the electronic device to generate a first three-dimensional coordinate and recording time that the operation object appears at the first position as a first time;
the detecting at least one second position of the at least one operation object near the screen to generate at least one second three-dimensional coordinate further comprises:
detecting a second position of the operation object near the screen to generate a second three-dimensional coordinate and recording time that the operation object appears at the second position as a second time;
the performing at least one relative operation on the screen according to a movement of the at least one operation object from the at least one first three-dimensional coordinate to the at least one second three-dimensional coordinate and at least one second two-dimensional coordinate which is a projection of the at least one second three-dimensional on the screen further comprises:
computing a first speed that the operation object moves from the first position to the second position according to the first three-dimensional coordinate, the second three-dimensional coordinate, the first time and the second time; and
determining that the operation object selects a second two-dimensional coordinate which is a projection of the second three-dimensional on the screen if the first speed conforms to a first threshold speed.
